(19) United States
(12) Patent Application Publication
(10) Pub. No.: US 2002/0051174 A1
(43) Pub. Date: May 2, 2002

(54) Method, system and storage medium for document processing

(76) Inventors: Michael Betts, Wethersfield, CT (US); Stephen Barrante, New Britain, CT (US); Manuel Couceiro, E. Granby, CT (US)

Correspondence Address: Philmore H. Colburn II, 55 Griffin Road South, Bloomfield, CT, 06002, US

(21) Appl. No.: 09/769,011

(22) Filed: Jan. 24, 2001

Related U.S. Application Data
(60) Provisional application No. 60/177,773, filed on Jan. 24, 2000.

(51) Int. Cl. B41B 1/00

(52) U.S. Cl. 358/1.15

(57) ABSTRACT

A method of document processing which is fully automated and coordinated from a central cite while many of the task are performed at remote locations is presented. The method employs remote job management to perform job manipulation and editing, archival and retrieval, secure printing, use of virtual printers, static forms overlay, imaging engine scanning, and tandem and cluster printing. The method provides for the ability to create and/or recommend applications that can be easily integrated with a provider's engines in creating a complete printing solution. A system and storage medium for implementing the method are also disclosed.

This application claims the benefit of U.S. Provisional Application Serial No. 60/177,773 filed Jan. 24, 2000.

### BACKGROUND OF THE INVENTION

The invention relates to a method, system and storage medium for document processing. Document processing has mainly been a manual task, which is both time consuming and expensive. Such manual tasks include editing a document and printing a job (i.e., printing a number of copies of the document). These tasks may include overlaying, imaging and other art type functions.

### BRIEF SUMMARY OF THE INVENTION

An exemplary embodiment of the invention is a method of document processing which is fully automated and coordinated from a central cite while many of the task are performed at remote locations. The method employs remote job management to perform job manipulation and editing, archival and retrieval, secure printing, use of virtual printers, static forms overlay, imaging engine scanning, and tandem and cluster printing. The method provides for the ability to create and/or recommend applications that can be easily integrated with a provider's engines in creating a complete printing solution. A system and storage medium for implementing the method are also disclosed.

### BRIEF DESCRIPTION OF THE DRAWINGS

Referring now to the drawings, wherein like elements are numbered alike in the several FIGURES:

FIG. 1 is a block diagram of an exemplary system for document processing in accordance with the present invention;

FIG. 2 is a flowchart of an exemplary process of the document processing of the present invention;

FIGS. 3-8 depict an exemplary interface displaying a Main menu for the document processing of the present invention;

FIGS. 9-13 depict an exemplary interface displaying a Distribution Printing menu for the document processing of the present invention;

FIGS. 14-17 depict an exemplary interface displaying a Host menu for the document processing of the present invention;

FIGS. 18-20 depict an exemplary interface displaying a Line Data menu for the document processing of the present invention;

FIG. 21 depicts an exemplary interface displaying a Hardware & Software menu for the document processing of the present invention;

FIG. 22 depicts an exemplary interface displaying a Software menu for the document processing of the present invention;

FIGS. 23 and 24 depict an exemplary interface displaying a TIFF menu for the document processing of the present invention; and

FIGS. 25-27 depict an exemplary interface displaying a CGM menu for the document processing of the present invention.

### DETAILED DESCRIPTION

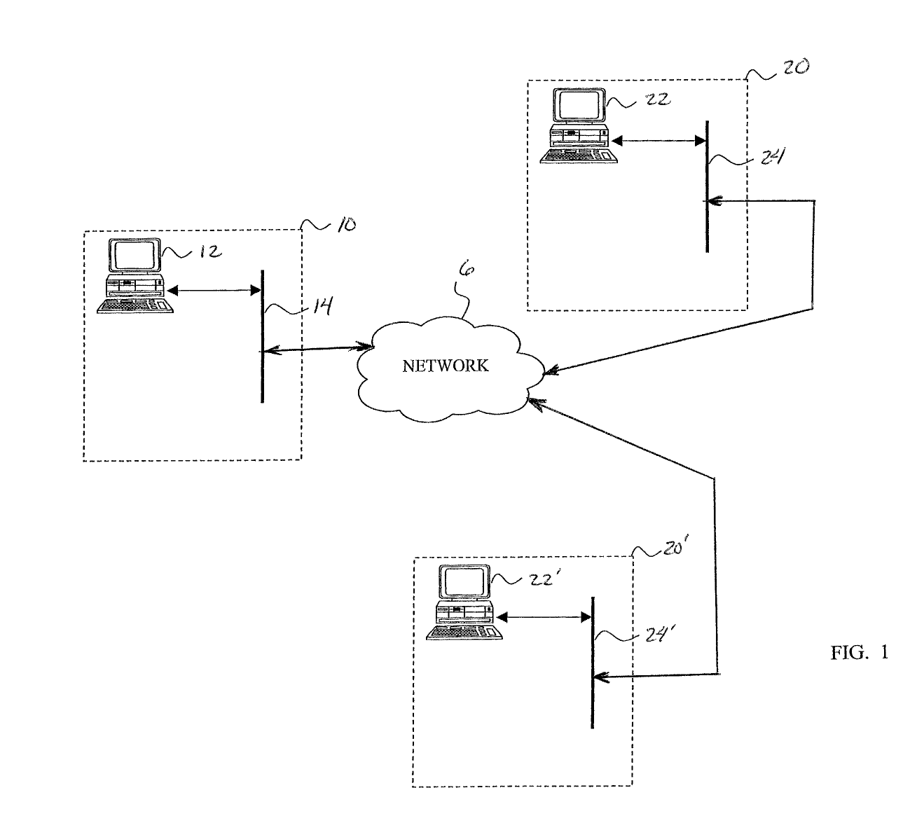

Referring to FIG. 1, a block diagram of an exemplary system for providing document processing is generally shown. The system of FIG. 1 includes a provider node 10 that is supplying a deliverable (e.g., goods or services) to a customer (not shown). In an exemplary embodiment, the provider 10 provides document processing data to other nodes, such as node 20, which may also be the customer. The document processing data is communicated electronically via a network 6. The network 6 may be any type of known network including a wide area network (WAN), secure network (e.g., extranet, virtual private network), global network (e.g., Internet), etc. As described herein, during the process of communicating document data, a machine readable indicia is generated which facilitates such communication.

Node 10, 20 includes a system 12, 22 that may be implemented using a general-purpose computer or one or more commercially available servers (including related periphery devices, such as printers) executing computer programs for carrying out the processes described herein. Alternatively, system 12, 22 may be implemented using a device programmed primarily for accessing network 6 such as a network computer. System 12, 22 may be coupled to network 6 in a wireless manner. In a preferred embodiment, the network 6 is the Internet and each system 12, 22 executes a user interface application (e.g., web browser) to contact the other nodes through the network 6. Typically, the node 10, 20 includes one or more systems 12, 22 coupled to a network 6 through a firewall 14, 24. System 12, 22 may also act as a network server to interact with other systems. It is understood that the system 12, 22 may be implemented by more than one physical device, such as a number of servers each performing one or more of the functions described herein.

This data communication may also include a customer's request for a print product that is sent to the provider 10 via the network 6. Print product includes, for example, any documentation that requires processing or management, and is not limited to physically printed material but may also include an electronic document.

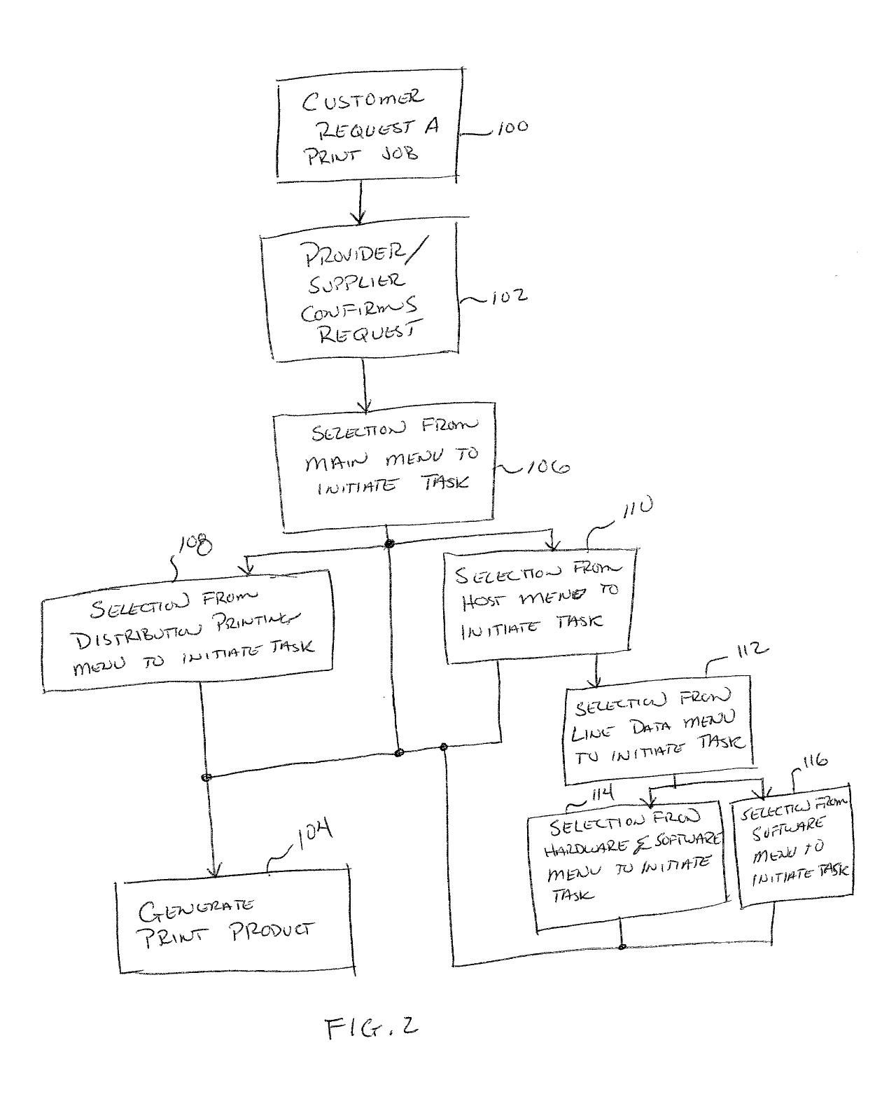

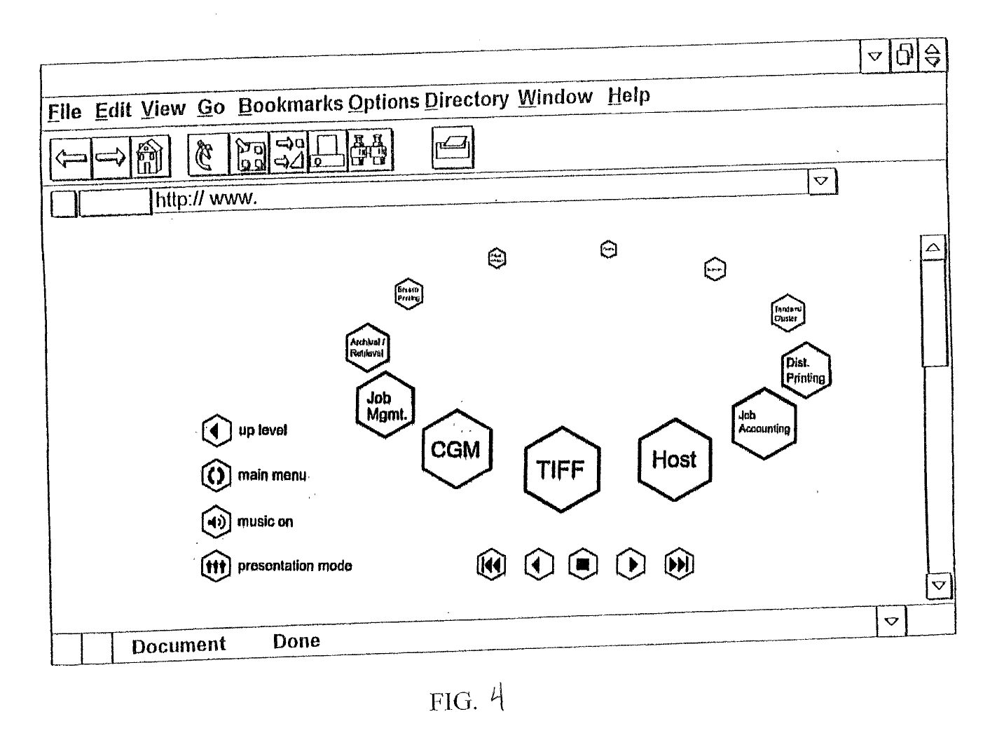

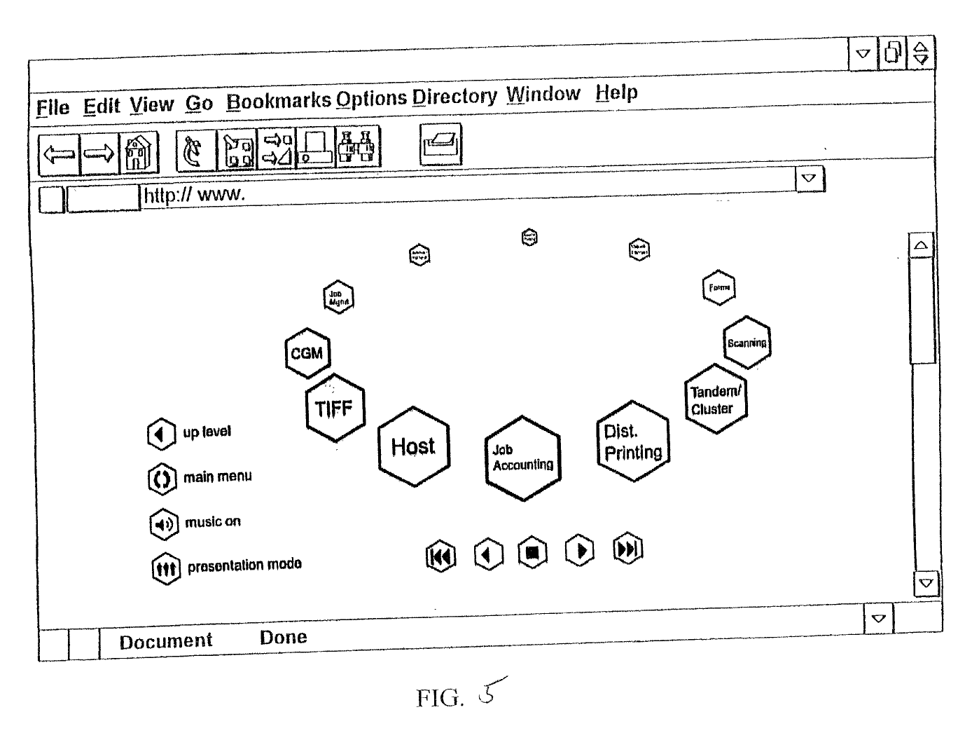

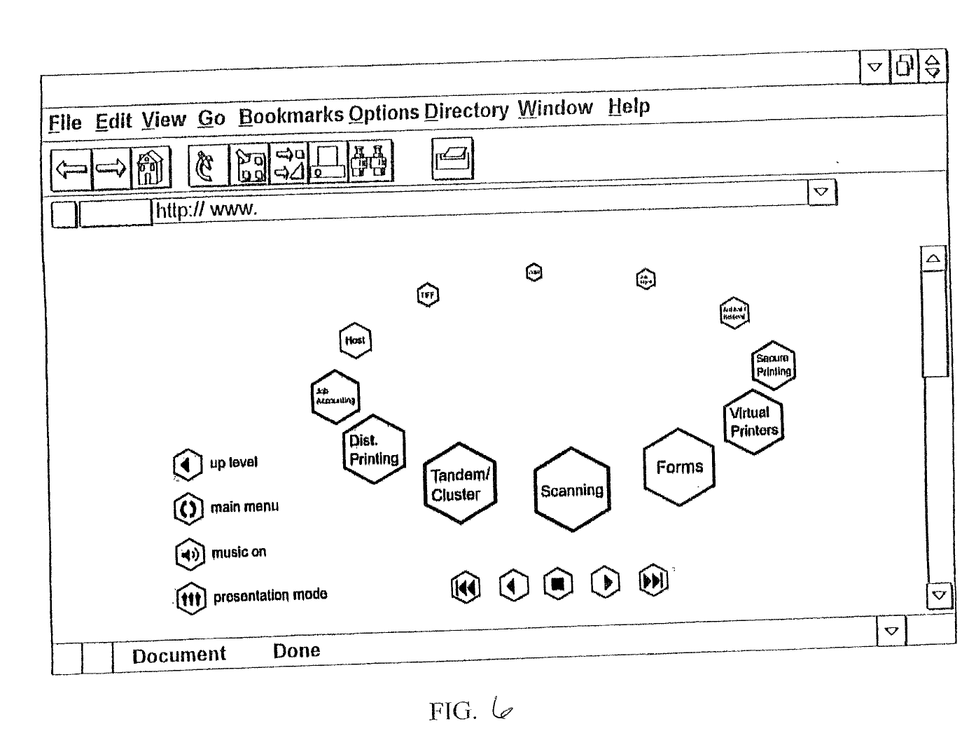

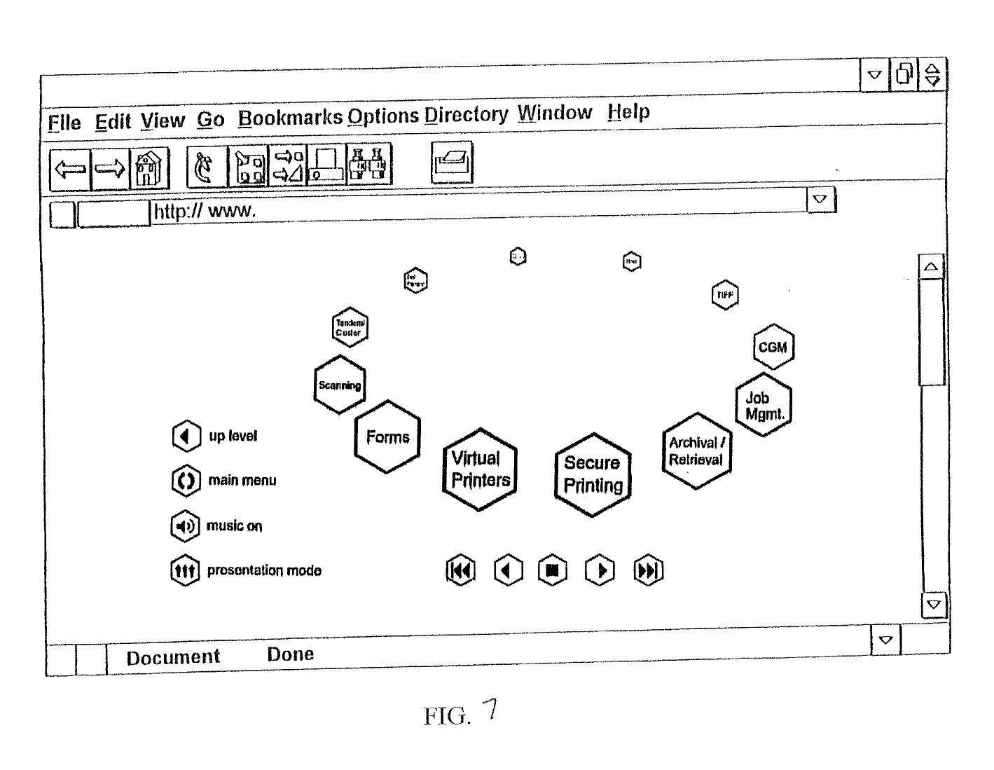

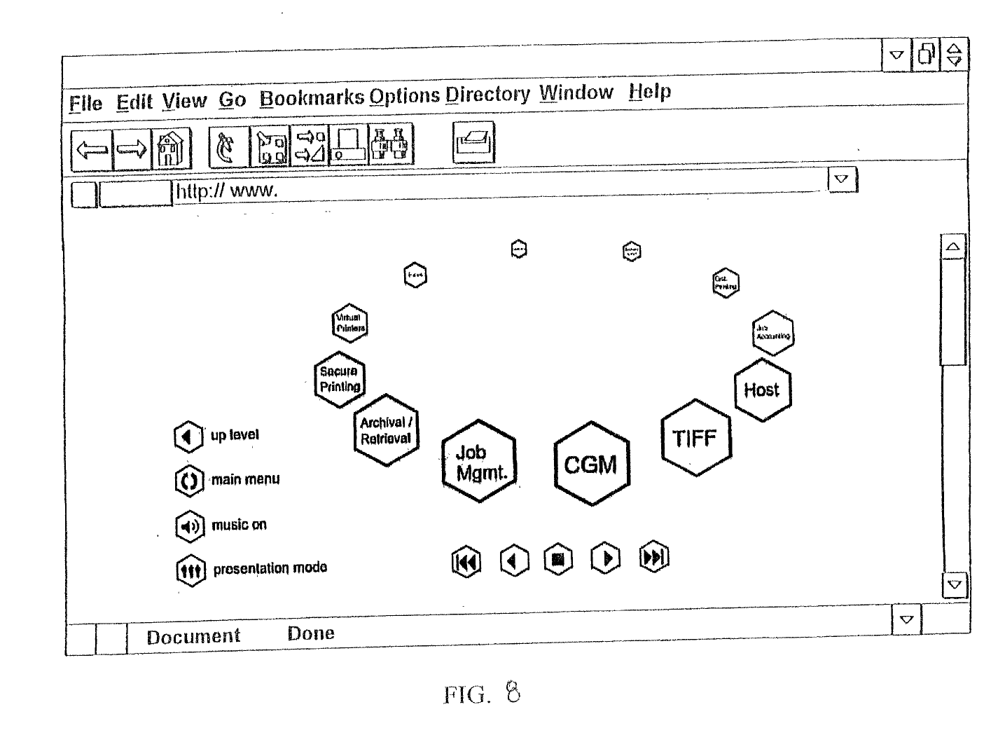

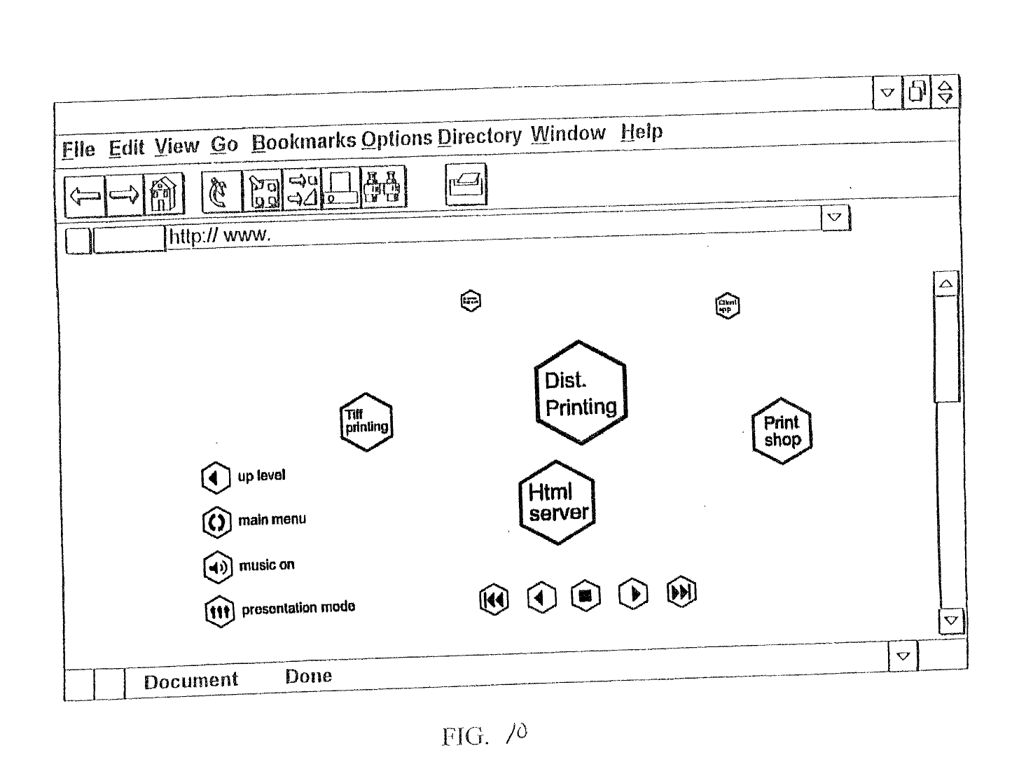

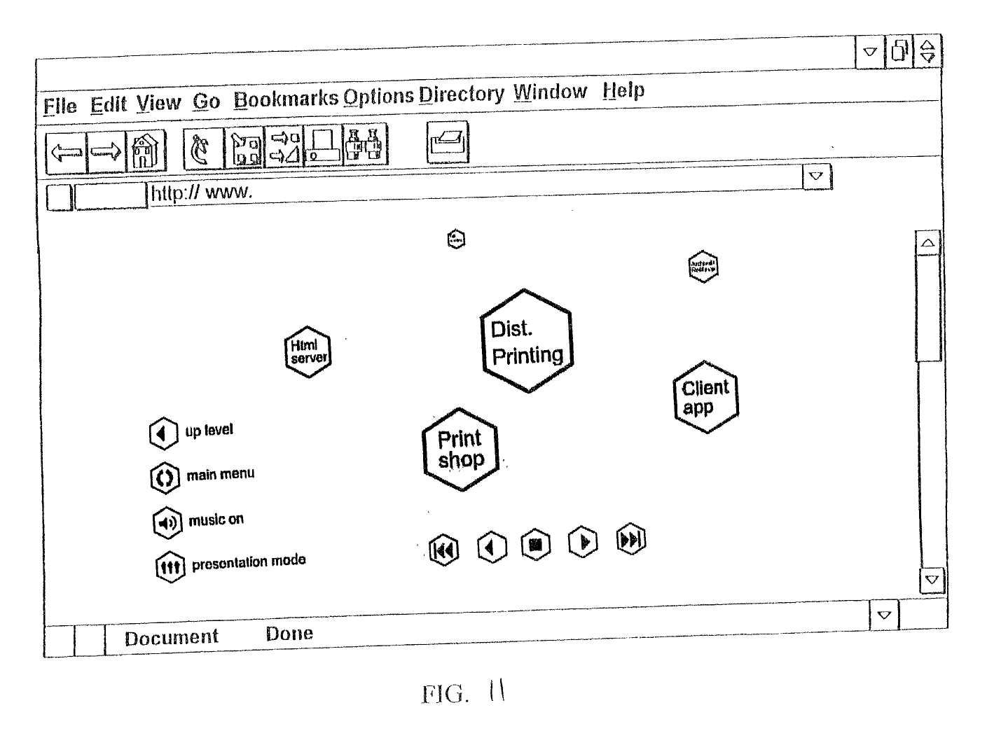

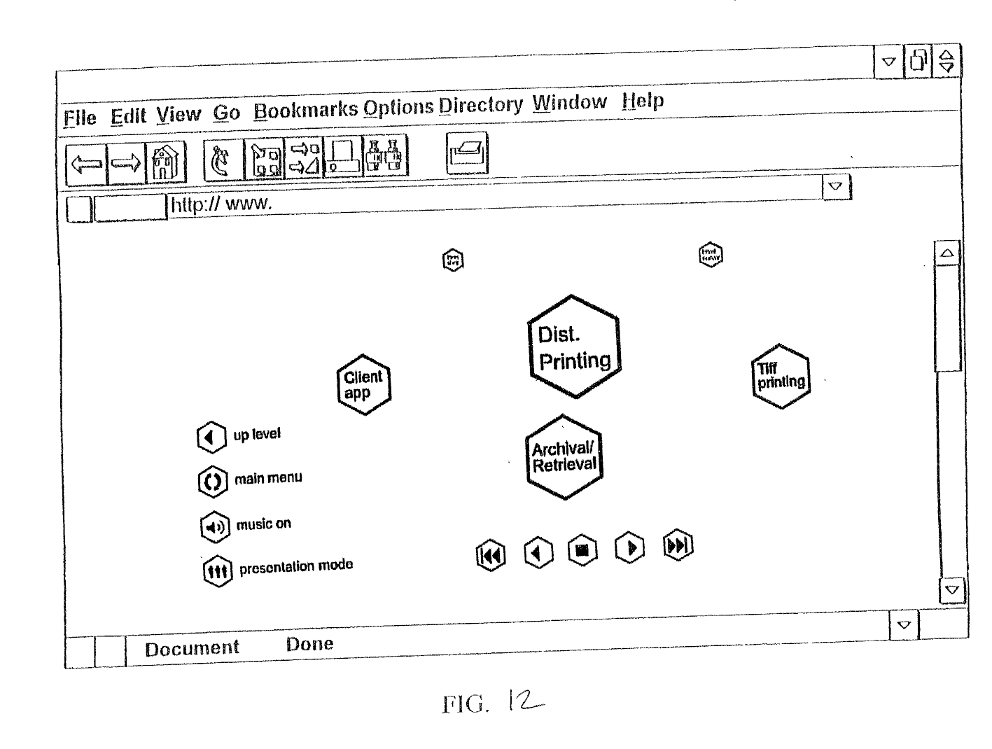

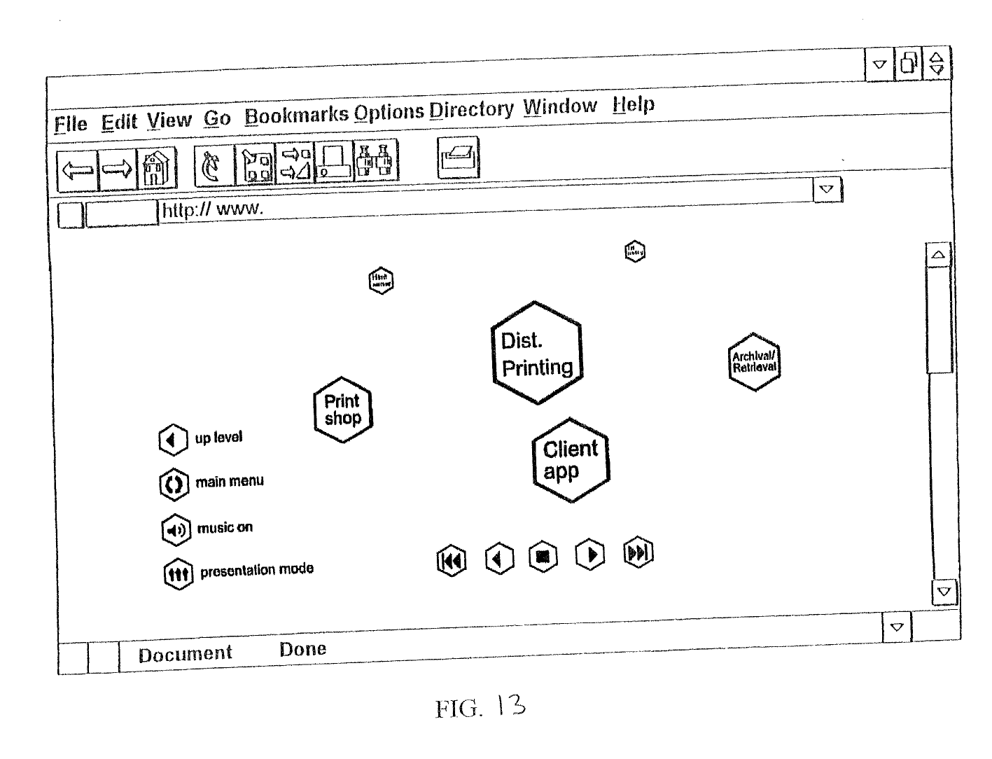

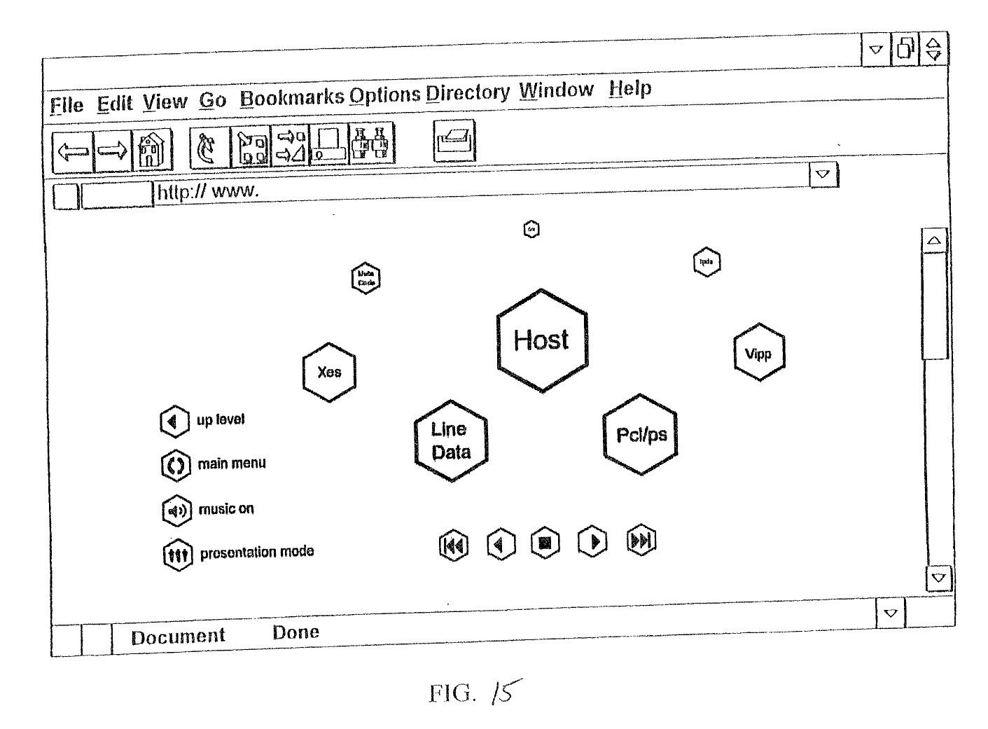

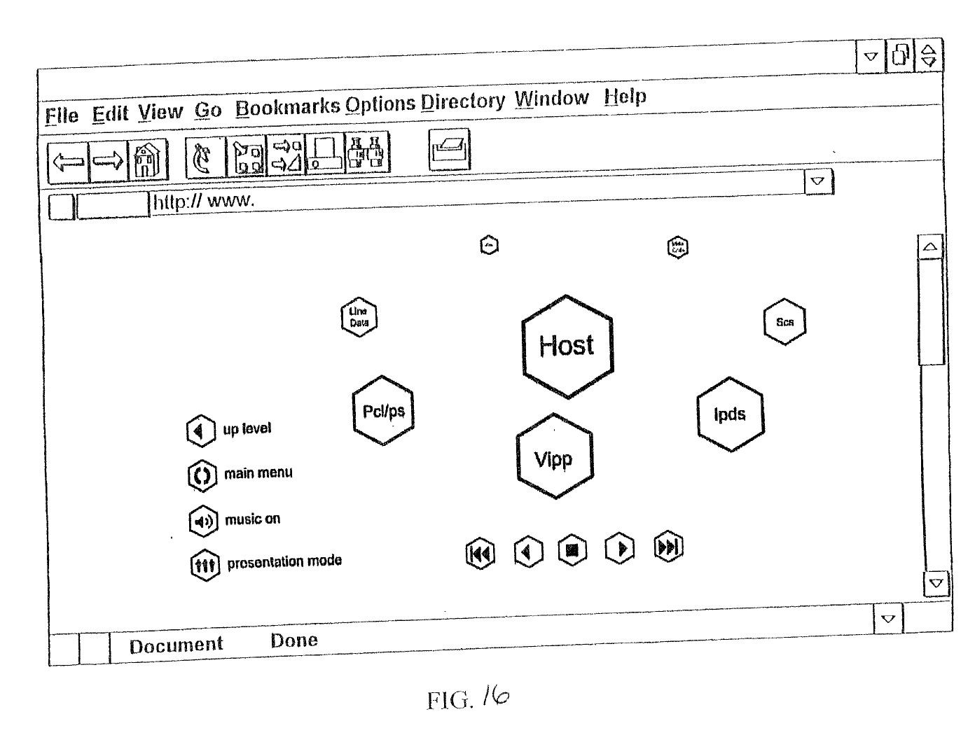

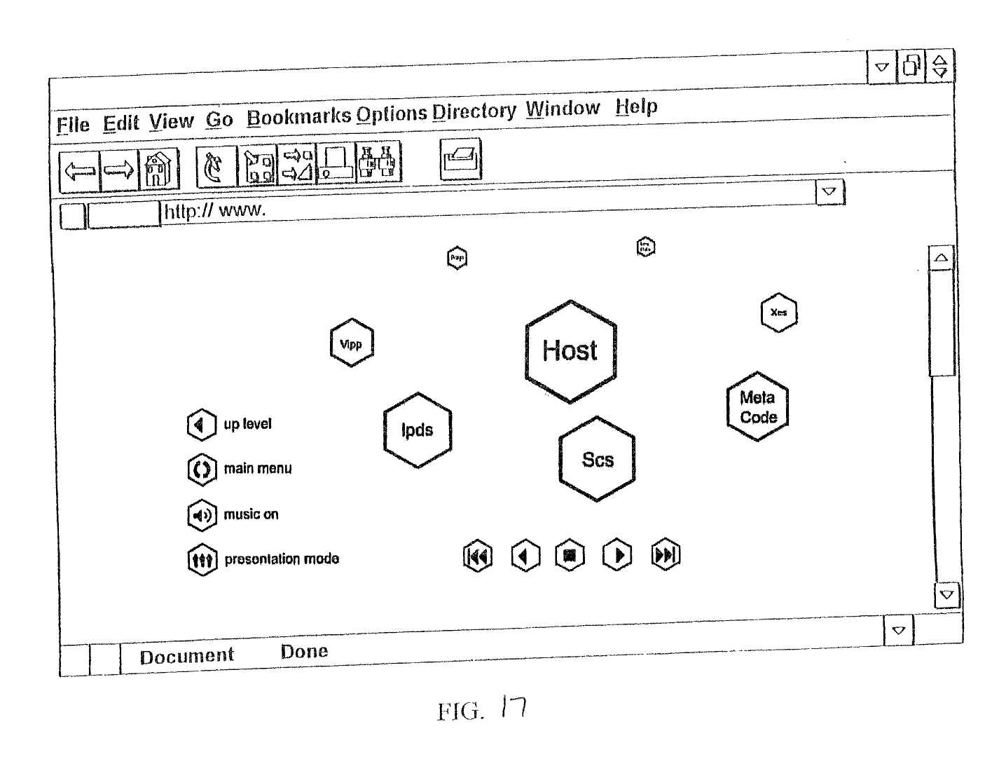

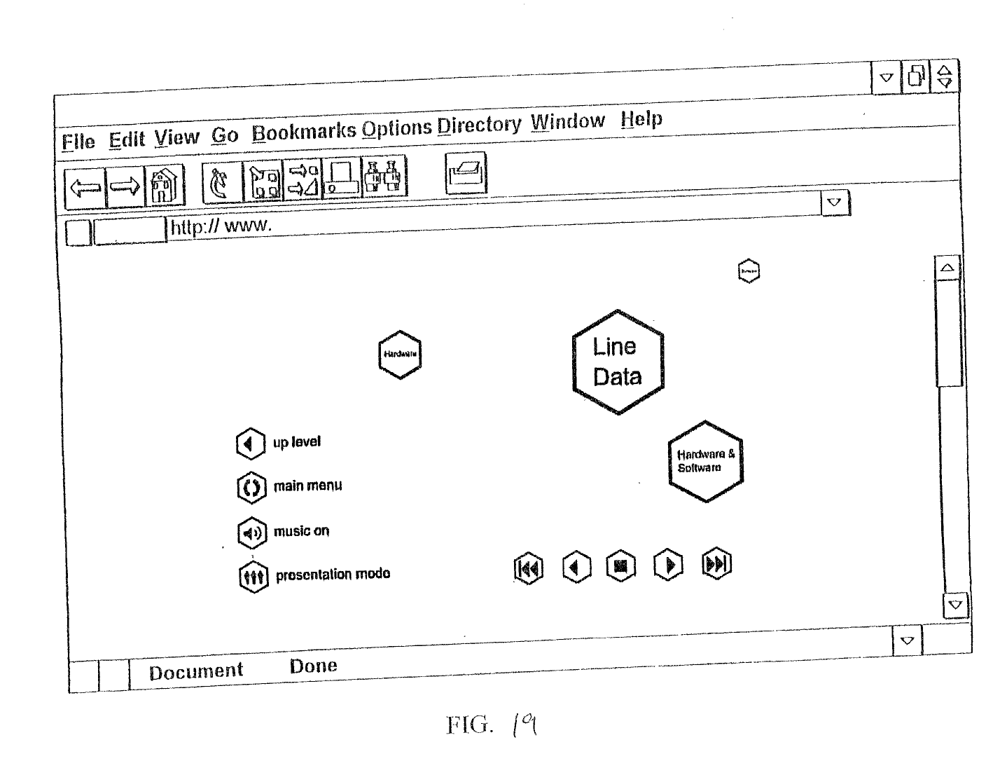

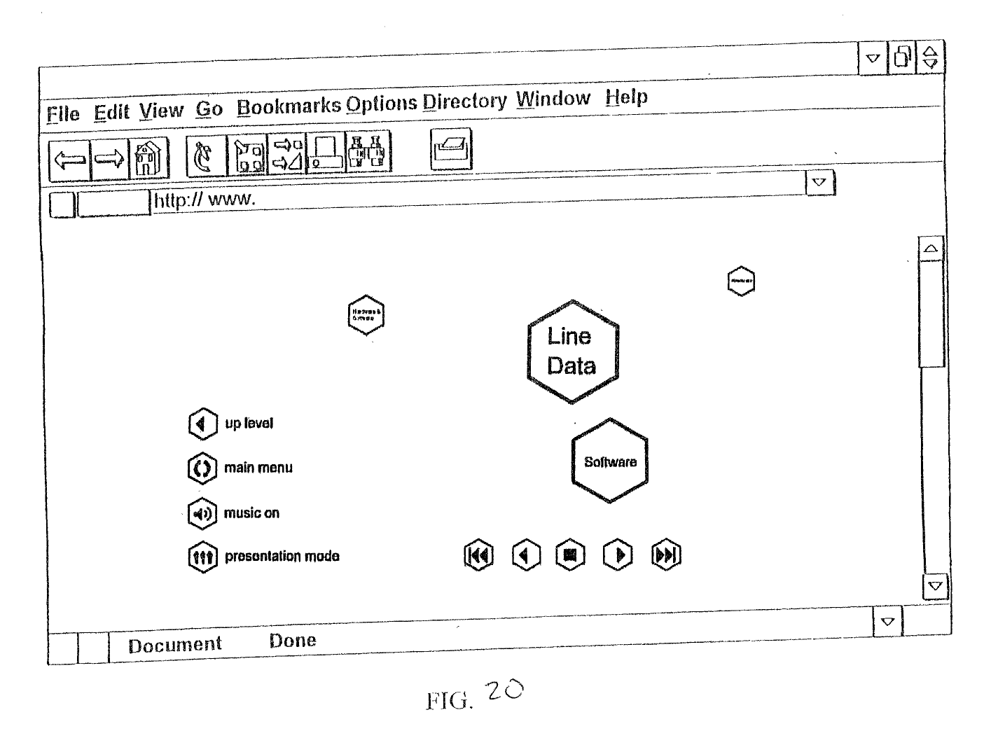

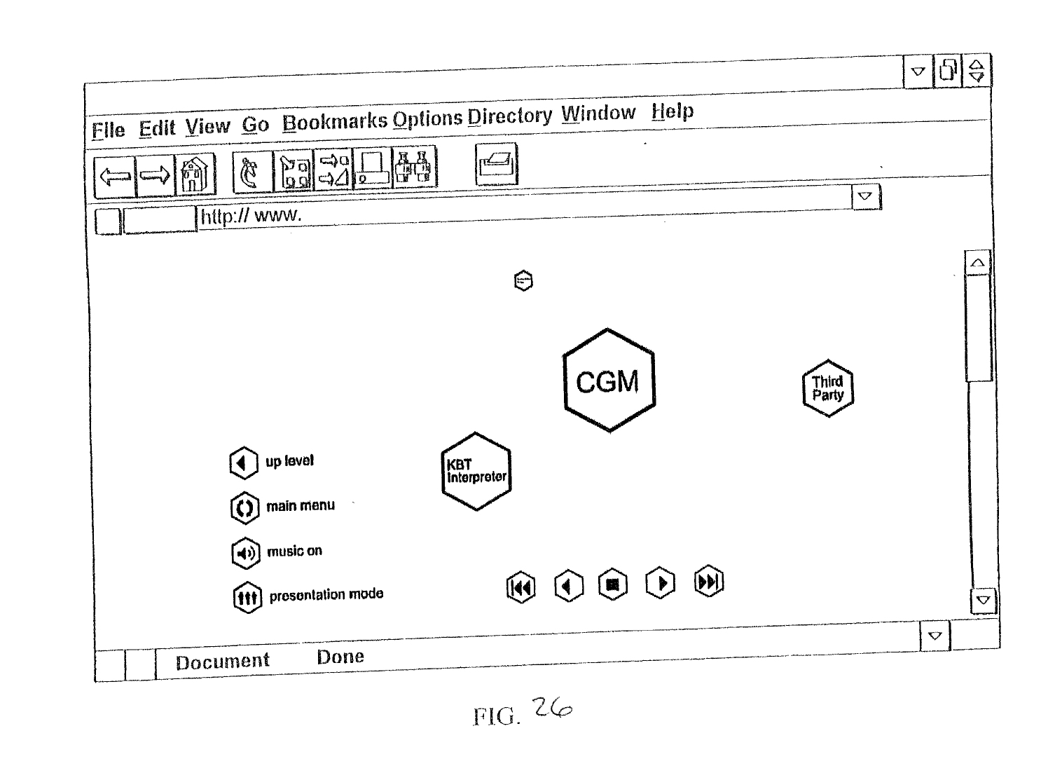

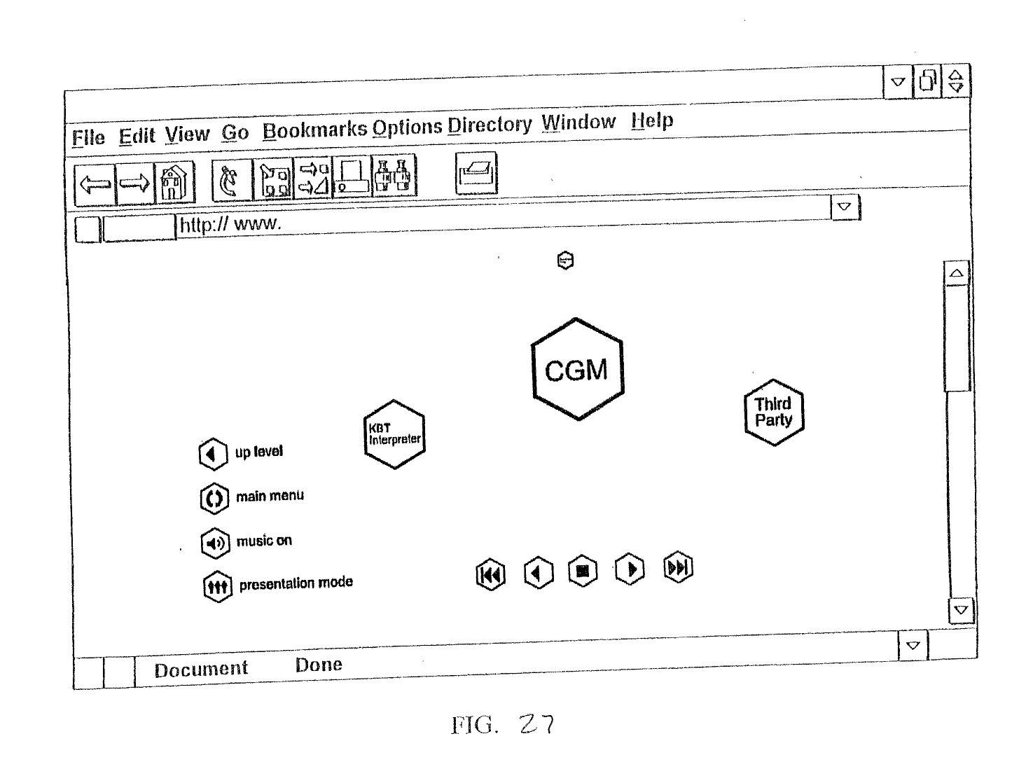

Operation of the system will now be described with reference to FIGS. 2-27. Document processing is described which is fully automated and coordinated from a central cite while many of the task are performed at remote locations.

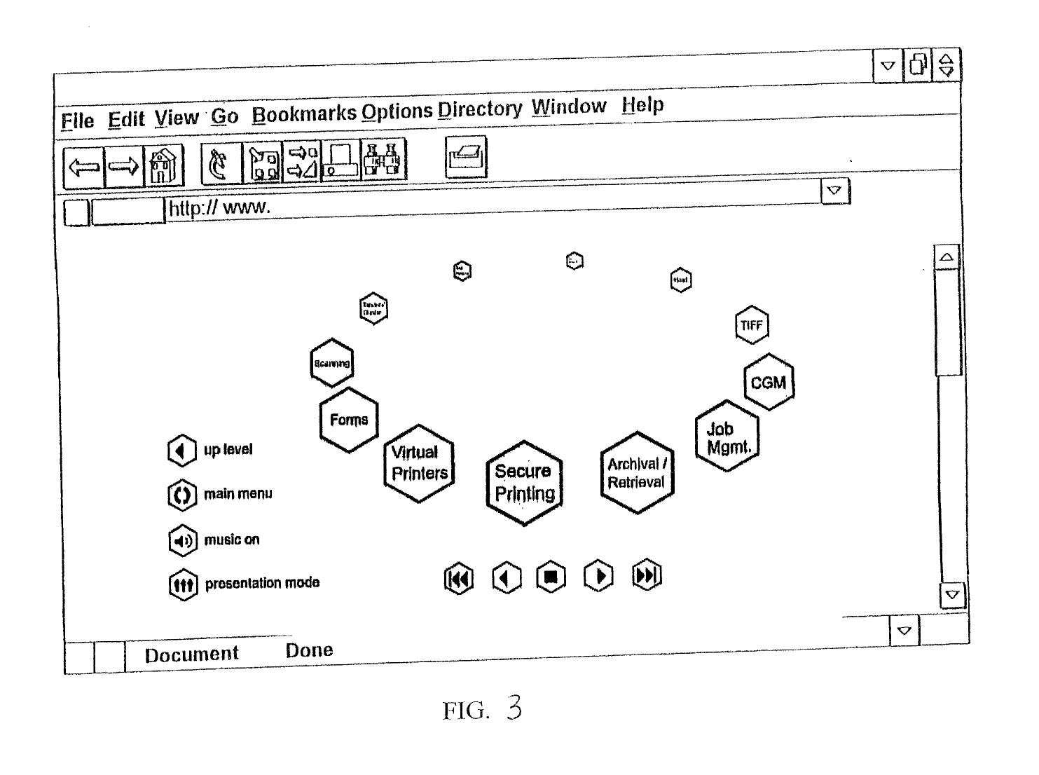

Referring to FIG. 2, a flow chart illustrating an exemplary process for document processing is generally shown. At step 100, a customer request a print job (product), in the present example, from a node 12 over the internet, and provides the required data documentation, instructions as to what print product is required, and/or where and how the required data documentation can be obtained (e.g., the required data documentation may be located at another node). At step 102, the provider confirms the request, in the present example, from node 10 over the Internet. The provider performs document processing in accordance with the present invention to generate the print product, at step 104. Document processing includes selecting from a main menu a task, at step 106, of (1) Job Management, (2) Archival/Retrieval, (3) Secure Printing, (4) Virtual Printers, (5) Forms, (6) Scanning, (7) Tandem/Cluster, (8) Distribution Printing, (9) Job Accounting, (10) Host, (11) TIFF (a TIFF file format), and (12) CGM (a CGM format), such file formats being known in the art. FIGS. 3-8 is an exemplary interface depicting the Main menu. It will be appreciated that all of the above task may not be applicable to every print job, and that which tasks are performed is dictated by the particular print job, such being readily apparent to one skilled in the art.

Selection of Job Management initiates a routine to provide for the ability to make changes/modify to jobs on a per jog, page, paragraph, and/or word changes, as well as being able to change job parameters, such as stapling, duplex/simplex, amount of copies and/or paper sizes/trays. Also, the ability to move, store, delete, manipulate, change the order of, and view job in a centralized remote location is provided.

Selection of Archival/Retrieval initiates a routine to provide for the ability to store and retrieve digitized documents/jobs in a format that may or may not allow for job editing on a page, or job basis, to a local and/or remote system.

Selection of Secure Printing initiates a routine to allow for a user to send single or multiple files to the printer, for immediate retrieval by the user. In one embodiment, a user will need to walk to the printer, enter their mailbox number and password to release the jobs. If the jobs are not accessed within an adequate, predetermined, amount of time, the job may be deleted from the system.

Selection of Virtual Printers initiates a routine to provide for a mechanism of setting up multiple print queues for a single physical printer. Each queue allows for certain features to be turned on/off for all jobs that get passed to the physical printer via that queue. For example, one queue might be setup as a “duplex” queue while another one might be setup as a “staple” queue. This would mean that all jobs sent to the duplex queue would be duplexed and all jobs sent to the staple queue would be stapled.

Selection of Forms initiates a routine to provide for an overlay of static forms. Overlay is a mechanism in which a form with blank fields is sent to the printer and stored in the print engine allowing the ability for data streams to be merged with the form at the user's request, on demand. This method drastically reduces the amount of Local Area Network (LAN) traffic and increases print throughput because the form is pre-Ripped and/or preloaded into the printer's RAM and does not need to be re-Ripped/loaded again for every additional page. For example, placing the same company logo on every page (with it only needing to be downloaded to the printer once) and still be adding different body of the document to every page.

Selection of Scanning initiates a routine to provide for imaging engine scanning. An engine is a hybrid copier/printer, which utilizes the copier's scanning abilities, to capture and output the image to a software file, instead of it being printed. It will be appreciated that the scanner does not need to be part of the print engine itself, but instead can be a separate piece of hardware that is integrated into the printing system.

Selection of Tandem/Cluster initiates a routine to provide for utilization of tandem printers or cluster printers. Tandem printers are more than one print engine (e.g., 2 or 3) driven from a single print controller but treated as separate print engines, such as two Xerox DocuTech 65 devices. Tandem printers increase the effective print throughput by being able to a print job #1 on an engine #1 and a job #3 on an engine #2 simultaneously, but is limited because a single job cannot split across the two engines. Cluster printers are an array of identical or dissimilar devices controlled from a single print controller that treat all of the individual print engines as a single “virtual” print engine capable of splitting and sharing a single job, such as T/R Systems MicroPress, capable of driving from two to eight devices. A print server, e.g., Link Com's PrintServer, is utilized to connect printers with parallel ports to a mixed LAN (Local Area Network) environment allowing use of LAN printers and host printers at the same time. This allows jobs to be printed both quickly and efficiently.

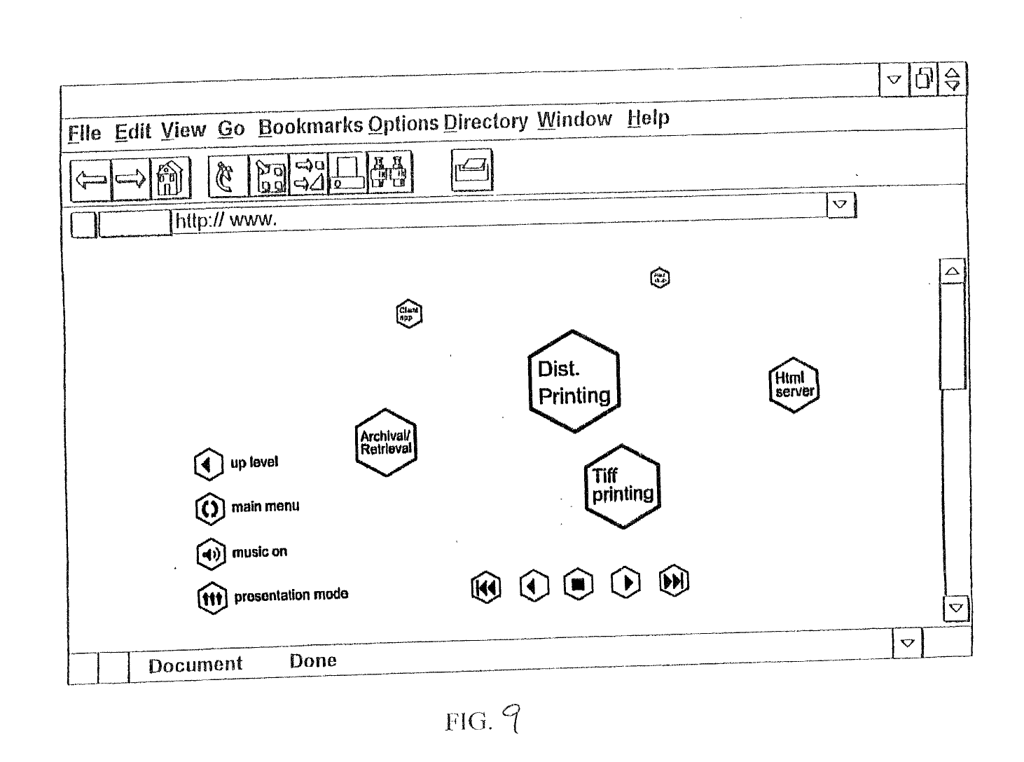

Selection of Distribution Printing prompts a Distribution Printing menu at step 108 where (1) Archival/Retrieval, (2) TIFF Printing, (3) Client Application, (4) Print Shop, or (5) HTML Server can be selected. FIGS. 9-13 is an exemplary interface depicting the Distribution Printing menu. Selection of Archival/Retrieval initiates a routine to provide for the ability to store and retrieve digitized documents/jobs in a format that may or may not allow for job editing on a page, or job basis, to a local and/or remote system.

Selection of Job Accounting initiates a routine to provide for the ability to obtain, via software, over the internet/intranet, all information, capable of being exported to other applications, that pertains to the system used to produce print jobs.

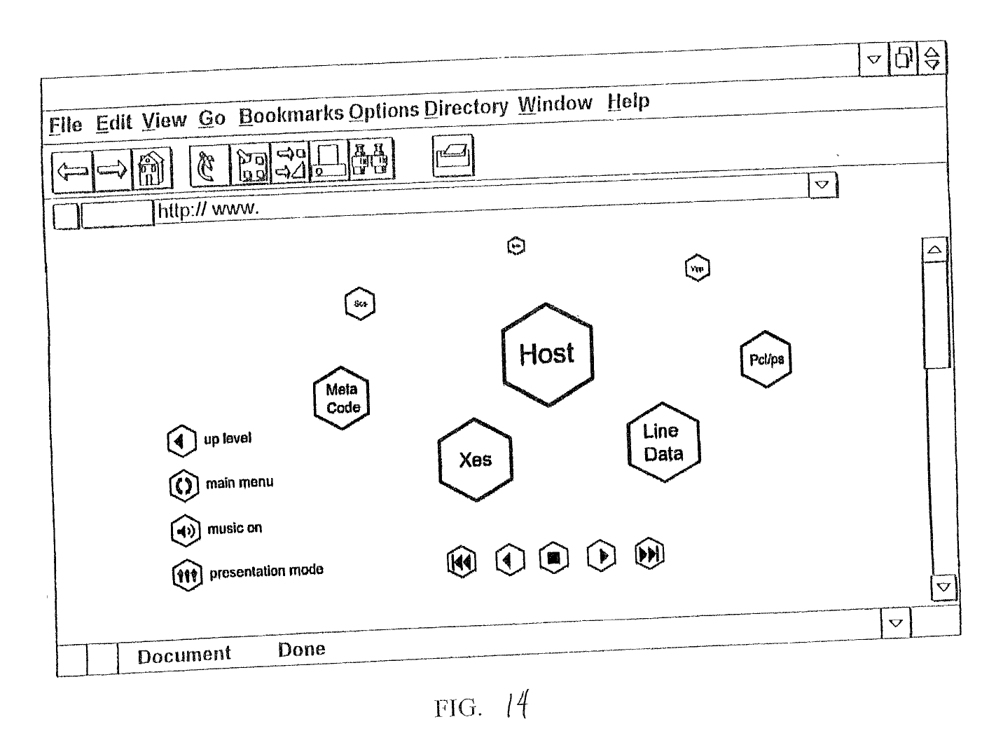

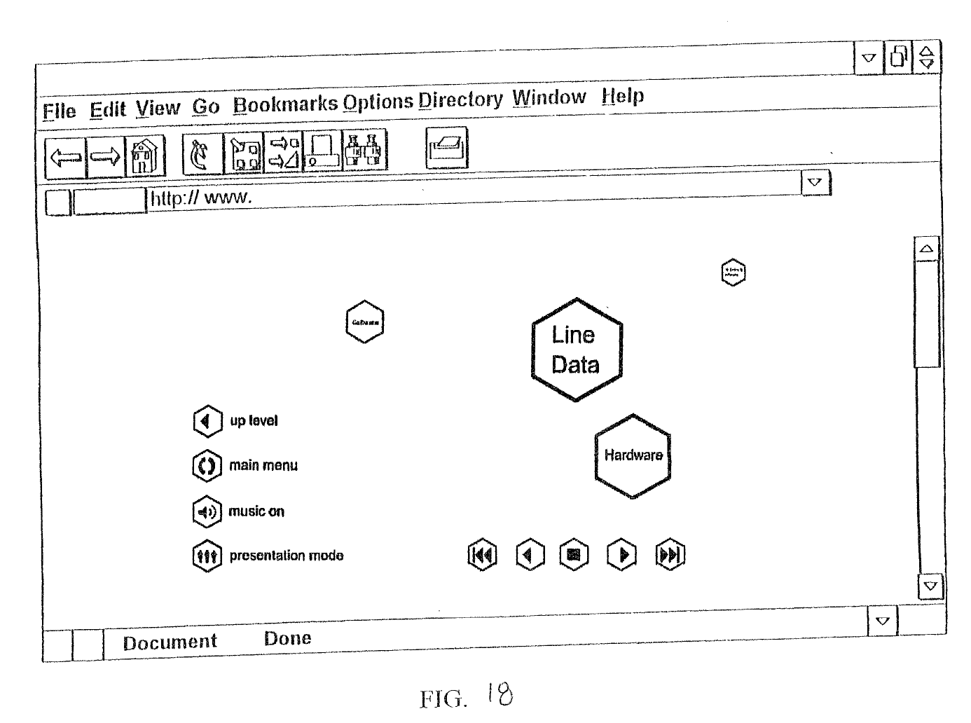

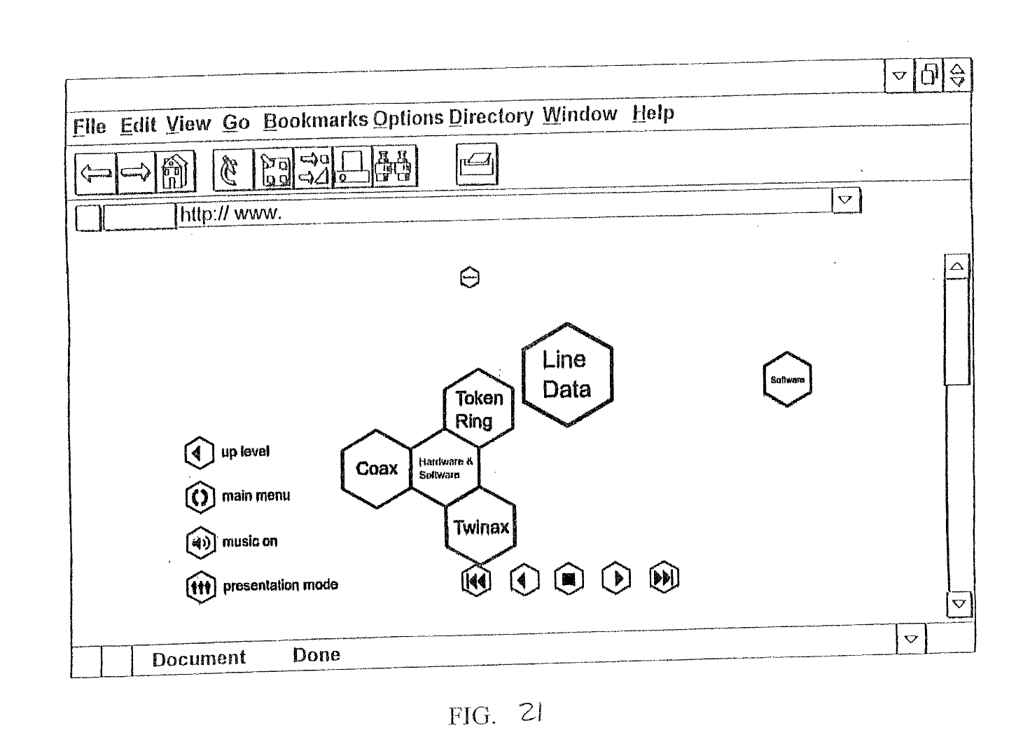

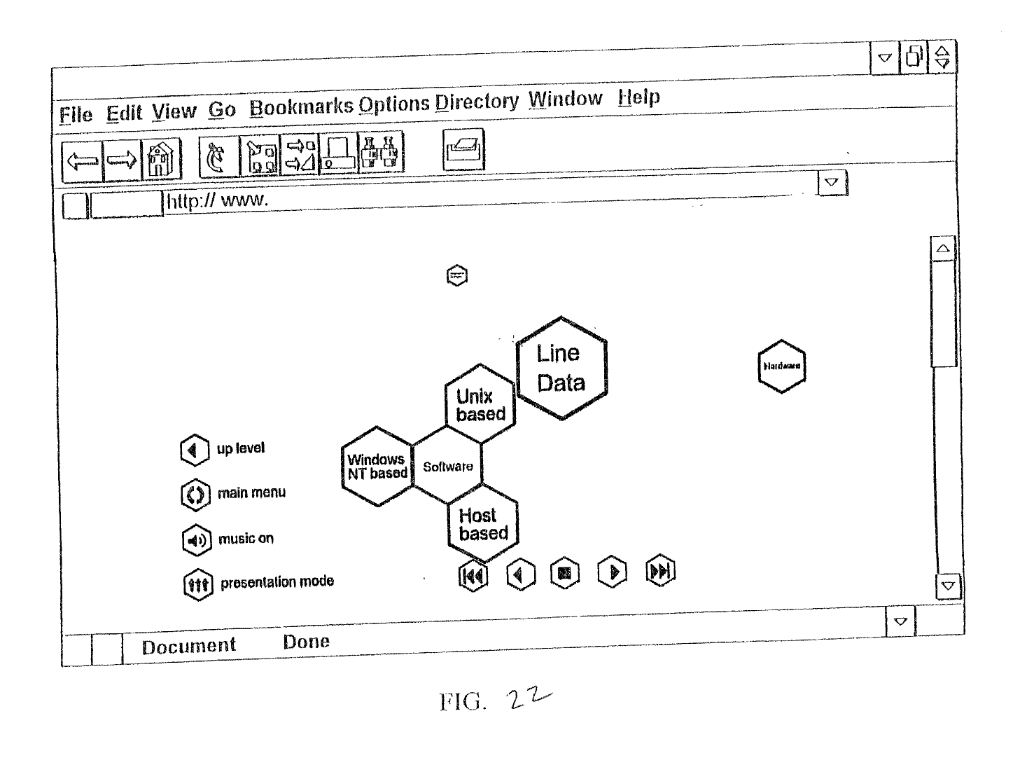

Selection of Host prompts a Host menu at step 110 where (1) SCS (language standard), (2) META Code, (3) XES (language standard), (4) Line Data, (5) PCL/PS (language standard), (6) VIPP (language standard), or (7) IPDS (language standard) can be selected, such language standards being known in the art. FIGS. 14-17 is an exemplary interface depicting the Host menu. Selection of Line Data prompts a Line Data menu at step 112 where (1) Software, (2) Hardware, or (3) Hardware & Software can be selected. FIGS. 18-20 is an exemplary interface depicting the Line Data menu. Selection of Hardware & Software prompts a Hardware & Software menu at step 114 where (1) Token Ring, (2) Coax, or (3) Twinax can be selected, with such being selected depending upon the network utilized. FIG. 21 is an exemplary interface depicting the Hardware & Software menu. Selection of Software prompts a Software menu at step 116 where (1) Unix Based, (2) Host Based, or (3) Windows NT Based can be selected, with such being selected depending upon the platform being run. FIG. 22 is an exemplary interface depicting the Software menu.

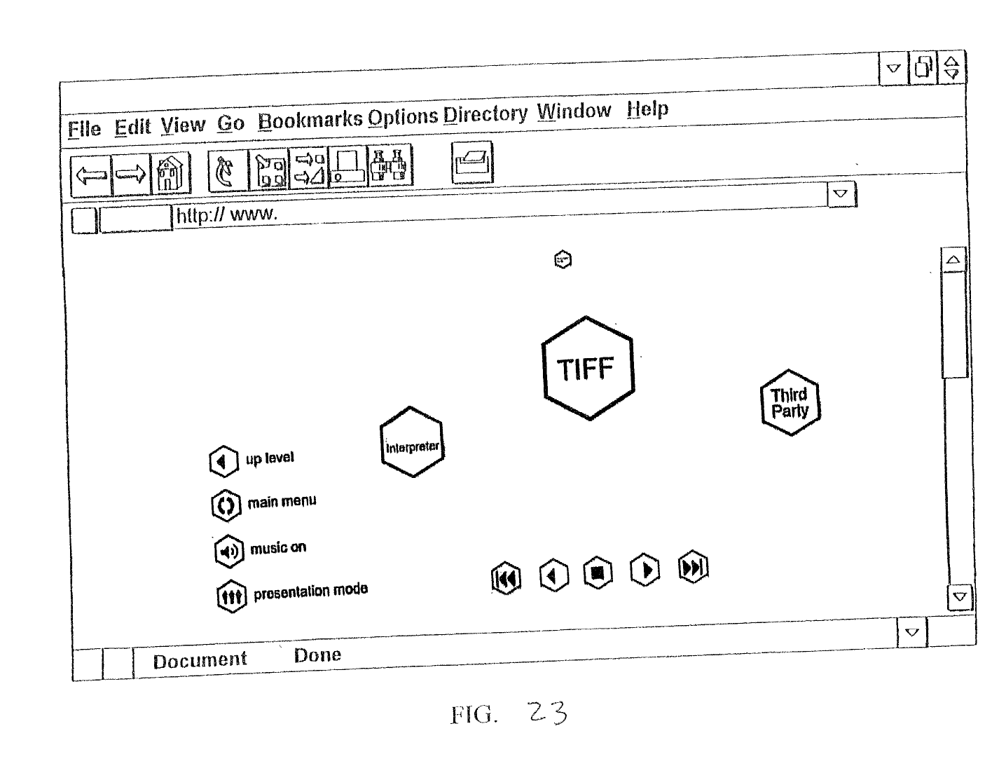

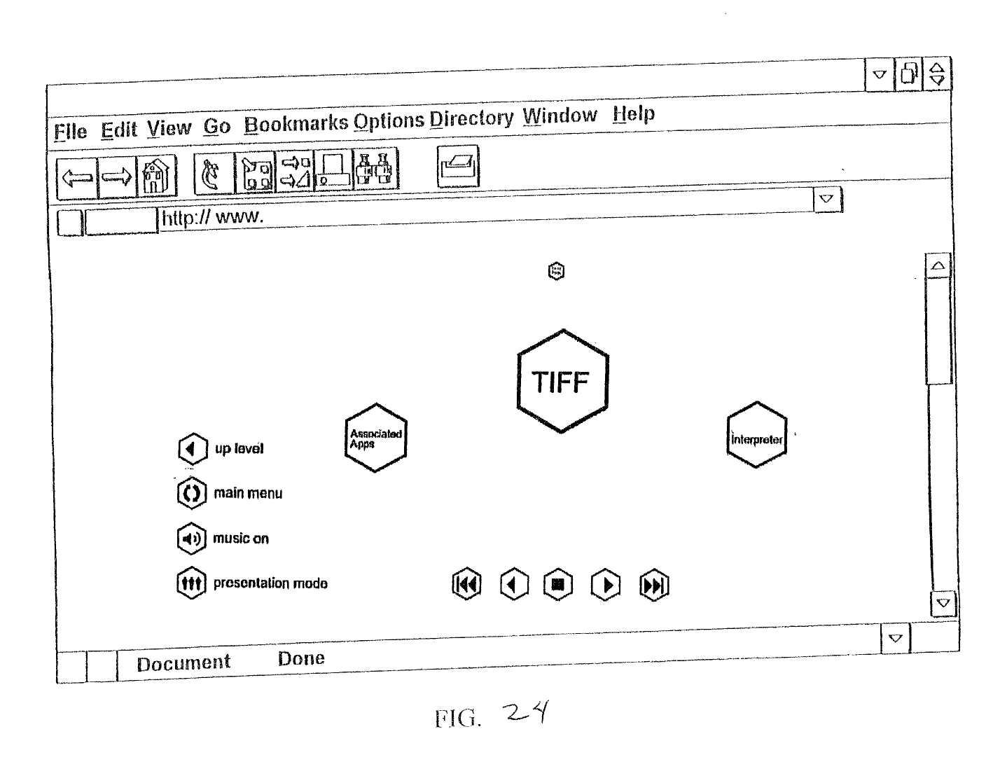

Selection of TIFF prompts a TIFF menu where (1) Associated Applications, (2) Interpreter, or (3) Third Party can be selected. FIGS. 23 and 24 is an exemplary interface depicting the TIFF menu.

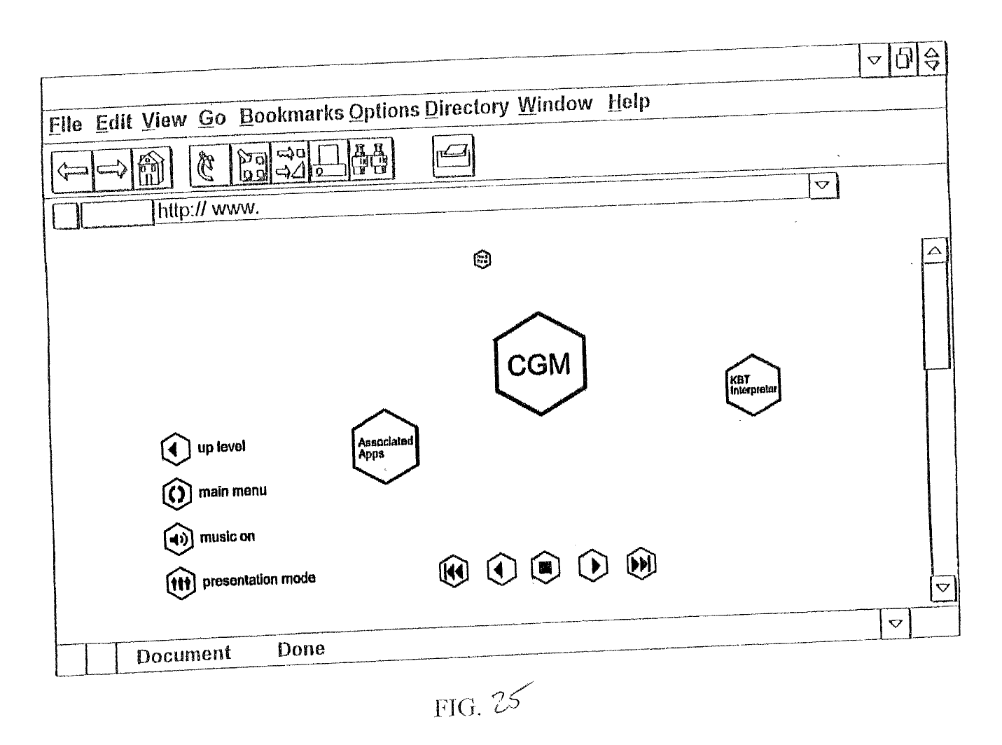

Selection of CGM prompts a CGM menu where (1) Associated Applications, (2) Interpreter, or (3) Third Party can be selected. FIGS. 25-27 is an exemplary interface depicting the CGM menu.

The system and method described above allows a customer to request a print product (job) and the provider (or supplier) to utilize the present document processing process to provide the print product. This reduces results in an efficient and cost effective method of document processing, which may be directed and/or task performed from remote locations.

As described above, the present invention can be embodied in the form of computer-implemented processes and apparatuses for practicing those processes. The present invention can also be embodied in the form of computer program code containing instructions embodied in tangible media, such as floppy diskettes, CD-ROMS, hard drives, or any other computer-readable storage medium, wherein, when the computer becomes an apparatus for practicing the invention. The present invention can also be embodied in the form of computer code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the essential scope thereof. Therefore, it is intended that the invention not be limited to the particular embodiments disclosed for carrying out the invention, but that the invention will include all embodiments falling within the scope of the appended claims.

What is claimed is:

1. A method of document processing comprising:
receiving at a supplier system, via a network, customer request data corresponding to a deliverable print product;
initiating task routines in response to selections made from a menu at the supplier system, said tasks routines selected in accordance with determinations made from the customer request data and include selections from a management task routine, an archival task routine, a retrieval task routine, a forms task routine, a scanning task routine, an accounting task routine, a host task routine, a TIFF task routine and a CGM task routine; and
initiating a printing task routine in response to a selection from the menu at the supplier system, the printing task routine generating the print product, wherein at least one of said initiating task routines or said initiating said printing task routine comprises initiating for execution at a task system remote from the supplier system.

2. The method of claim 1 wherein said initiating said printing task routine comprises said initiating for execution at the task system remote from the supplier system, the task system comprising a customer system.

3. The method of claim 1 wherein said printing task routine comprises a secure printing routine, a virtual printing routine, a tandem printing routine, a cluster printing routine, or a distribution printing routine.

4. The method of claim 3 wherein said initiating said task routines includes initiating said distribution printing task routine to provide for initiating said archival task routine, said retrieval task routine, a TIFF printing task routine, a client application task routine, a print shop task routine, or a HTML server task routine.

5. The method of claim 1 wherein said initiating said task routines includes initiating said host task routine to provide for initiating a SCS task routine, a META code task routine, an XES task routine, a line data task routine, a PCL/PS task routine, a VIPP task routine, or an IPDS task routine.

6. The method of claim 5 wherein said initiating said line data task routine provides for initiating a software task routine, a hardware task routine, or a hardware and software task routine.

7. The method of claim 6 wherein said initiating said hardware and software task routine provides for initiating a Token Ring task routine, a Coax task routine, or a Twinax task routine.

8. The method of claim 6 wherein said initiating said software task routine provides for initiating a Unix based task routine, a host based task routine, or a Windows NT based task routine.

9. A storage medium encoded with machine-readable program code for document processing, said program code including instructions for causing a computer to implement a method comprising:
receiving at a supplier system, via a network, customer request data corresponding to a deliverable print product;
initiating task routines in response to selections made from a menu at the supplier system, said tasks routines selected in accordance with determinations made from the customer request data and include selections from a management task routine, an archival task routine, a retrieval task routine, a forms task routine, a scanning task routine, an accounting task routine, a host task routine, a TIFF task routine and a CGM task routine; and
initiating a printing task routine in response to a selection from the menu at the supplier system, the printing task routine generating the print product, wherein at least one of said initiating task routines or said initiating said printing task routine comprises initiating for execution at a task system remote from the supplier system.

10. The storage medium of claim 9 wherein said method further comprises said initiating said printing task routine comprising said initiating for execution at the task system remote from the supplier system, the task system comprising a customer system.

11. The storage medium of claim 9 wherein said method further comprises said printing task routine comprising a secure printing routine, a virtual printing routine, a tandem printing routine, a cluster printing routine, or a distribution printing routine.

12. The storage medium of claim 1 I wherein said method further comprises said initiating said task routines including initiating said distribution printing task routine to provide for initiating said archival task routine, said retrieval task routine, a TIFF printing task routine, a client application task routine, a print shop task routine, or a HTML server task routine.

13. The storage medium of claim 9 wherein said method further comprises said initiating said task routines including initiating said host task routine to provide for initiating a SCS task routine, a META code task routine, an XES task routine, a line data task routine, a PCL/PS task routine, a VIPP task routine, or an IPDS task routine.

14. The storage medium of claim 13 wherein said method further comprises said initiating said line data task routine to provide for initiating a software task routine, a hardware task routine, or a hardware and software task routine.

15. The storage medium of claim 14 wherein said method further comprises said initiating said hardware and software task routine to provide for initiating a Token Ring task routine, a Coax task routine, or a Twinax task routine.

16. The storage medium of claim 14 wherein said method further comprises said initiating said software task routine to provide for initiating a Unix based task routine, a host based task routine, or a Windows NT based task routine.

17. The storage medium of claim 9 located with a system.

18. A data signal propagated over a propagation medium, said data signal encoded with machine-readable program code for document processing, said program code including instructions for causing a computer to implement a method comprising:
receiving at a supplier system, via a network, customer request data corresponding to a deliverable print product;
initiating task routines in response to selections made from a menu at the supplier system, said tasks routines selected in accordance with determinations made from the customer request data and include selections from a management task routine, an archival task routine, a retrieval task routine, a forms task routine, a scanning task routine, an accounting task routine, a host task routine, a TIFF task routine and a CGM task routine; and
initiating a printing task routine in response to a selection from the menu at the supplier system, the printing task routine generating the print product, wherein at least one of said initiating task routines or said initiating said printing task routine comprises initiating for execution at a task system remote from the supplier system.

19. The data signal of claim 18 wherein said method further comprises said initiating said printing task routine comprising said initiating for execution at the task system remote from the supplier system, the task system comprising a customer system.

20. The data signal of claim 18 wherein said method further comprises said printing task routine comprising a secure printing routine, a virtual printing routine, a tandem printing routine, a cluster printing routine, or a distribution printing routine.

21. The data signal of claim 20 wherein said method further comprises said initiating said task routines including initiating said distribution printing task routine to provide for initiating said archival task routine, said retrieval task routine, a TIFF printing task routine, a client application task routine, a print shop task routine, or a HTML server task routine.

22. The data signal of claim 18 wherein said method further comprises said initiating said task routines including initiating said host task routine to provide for initiating a SCS task routine, a META code task routine, an XES task routine, a line data task routine, a PCL/PS task routine, a VIPP task routine, or an IPDS task routine.

23. The data signal of claim 22 wherein said method further comprises said initiating said line data task routine to provide for initiating a software task routine, a hardware task routine, or a hardware and software task routine.

24. The data signal of claim 23 wherein said method further comprises said initiating said hardware and software task routine to provide for initiating a Token Ring task routine, a Coax task routine, or a Twinax task routine.

25. The data signal of claim 23 wherein said method further comprises said initiating said software task routine to provide for initiating a Unix based task routine, a host based task routine, or a Windows NT based task routine.
